(19) United States
(12) Patent Application Publication
(10) Pub. No.: US 2006/0087426 A1
(43) Pub. Date: Apr. 27, 2006

(54) Addressing business card

(76) Inventor: Yu-Feng Liang, Jhubei City (TW)

Correspondence Address: TROXELL LAW OFFICE PLLC, 5205 LEESBURG PIKE, SUITE 1404, FALLS CHURCH, VA, 22041, US

(21) Appl. No.: 11/228,226

(22) Filed: Sep. 19, 2005

(30) Foreign Application Priority Data
Oct. 22, 2004 (TW) 093216817

(51) Int. Cl. H04Q 7/00

(52) U.S. Cl. 340/539.13

(57) ABSTRACT

The present invention provides a business card with a longitude-and-latitude information, by which a user can easily finds a location of the business card's owner.

### FIELD OF THE INVENTION

The present invention relates to a business card; more particularly, relates to finding a location of the business card's owner with a longitude-and-latitude information stored in the business card.

### DESCRIPTION OF THE RELATED ART

A business card 4 of a prior art, as shown in FIG. 7, comprises a name area 41 and a communication area 42, where the name area 41 comprises the name of the business card's 4 owner, the name of the owner's working place, etc.; and the communication area 42 comprises the owner's information about communication telephone number, fax number, E-mail address, communication address, etc. With the information provided in the name area 41 and the communication area 42, the owner can do advertisement by a distribution of the business card 4.

Although the owner can do advertisement by the distribution of the business card 4 contained with the information provided in the name area 41 and the communication area 42, a communication address provided in the communication area 42 is only a description of the address so that it is not easy for a user who is not familiar with the roads or is a first-time visitor to find the location of the business card's 4 owner with the communication address provided. So, the prior art does not fulfill users' requests on actual use.

### SUMMARY OF THE INVENTION

Therefore, the present invention is an addressing business card, where a user easily finds a location of the business card's owner with a longitude-and-latitude information provided by a data element on the business card coordinated with a receiver.

To achieve the above purpose, the present invention is an addressing business card, comprising a main frame and a data element deposed on the main frame. The main frame comprises a name area and a communication area at proper places. The data element is deposed on the main frame, comprising a longitude-and-latitude information for a communication address in the communication area. Thus, the longitude-and-latitude information is obtained through using the receiver; and a location for the longitude-and-latitude information is displayed, with which a user can easily finds the location of the business card's owner. Accordingly a novel addressing business card is obtained.

### BRIEF DESCRIPTIONS OF THE DRAWINGS

The present invention will be better understood from the following detailed description(s) of the preferred embodiment(s) according to the present invention, taken in con junction with the accompanying drawings, in which

FIG. 1 is a perspective view of a first preferred embodiment according to the present invention;

FIG. 2 is a perspective view of a second preferred embodiment according to the present invention;

FIG. 3 is a perspective view of a third preferred embodiment according to the present invention;

FIG. 4 is a view showing a status of use according to the first preferred embodiment of the present invention;

FIG. 5 is a view showing a status of use according to the second preferred embodiment of the present invention;

FIG. 6 is a view showing a status of use according to the third preferred embodiment of the present invention; and

FIG. 7 is a perspective view of a prior art.

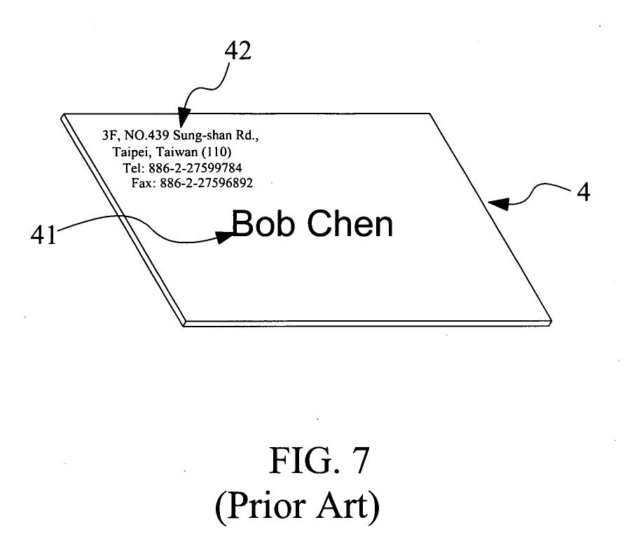

### DESCRIPTION OF THE PREFERRED EMBODIMENTS

The following descriptions of the preferred embodiments are provided to understand the features and the structures of the present invention.

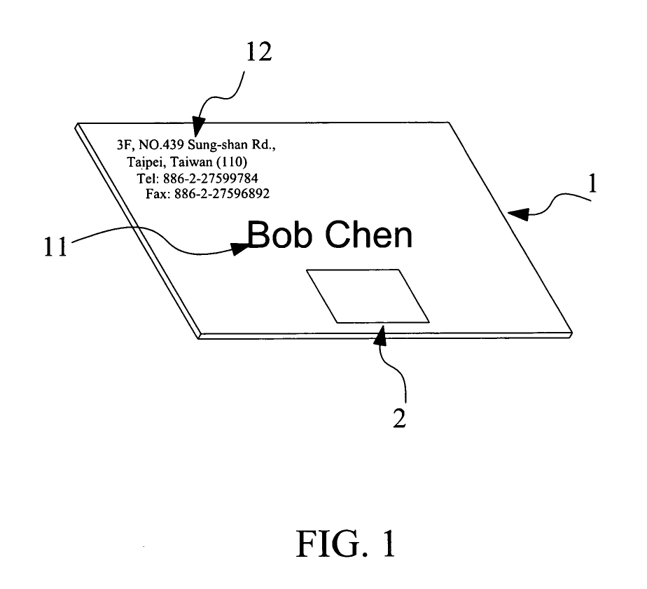

Please refer to FIG. 1 through FIG. 3, which are perspective views of a first, a second and a third preferred embodiments according to the present invention. As shown in the figures, the present invention is an addressing business card, comprising a main frame 1 and a data element 2, by which a user can easily find a location for the business card's owner. A name area 11 and a communication area 12 are deposed on a surface of the main frame 1. The name area 11 comprises some information of the business card's owner such as his/her name, his/her working-unit name, etc. The communication area 12 comprises information about communication telephone number, fax number, E-mail address, communication address, etc.

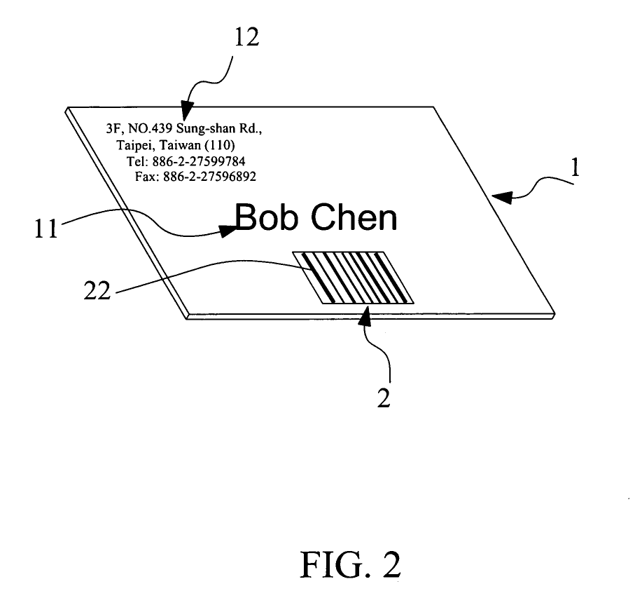

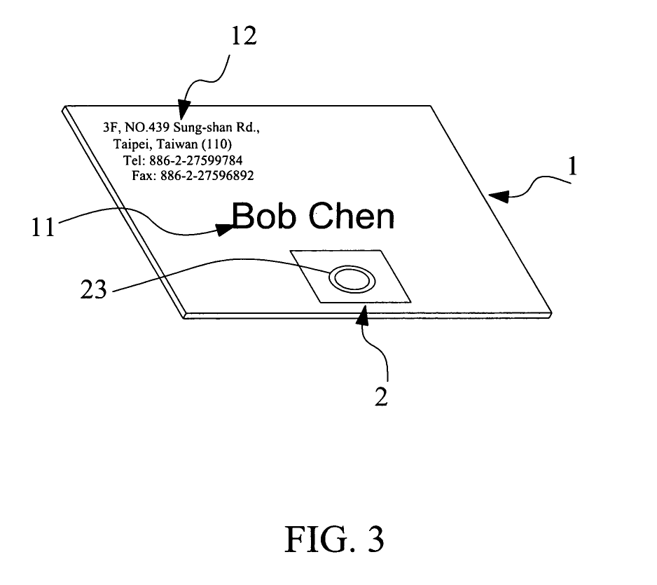

The data element 2 is deposed on a surface of the main frame 1, comprising a longitude-and-latitude information for the communication address shown in the communication area 12. The data element can comprise a description 21 of the longitude-and-latitude information of the communication address (as shown in FIG. 1). Or, the data element can comprise a bar code 22 for the longitude-and-latitude information of the communication address (as shown in FIG. 2). Or, the data element can comprise a sensor chip 23 storing the longitude-and-latitude information of the communication address (as shown in FIG. 3). As a result, a novel addressing business card is obtained.

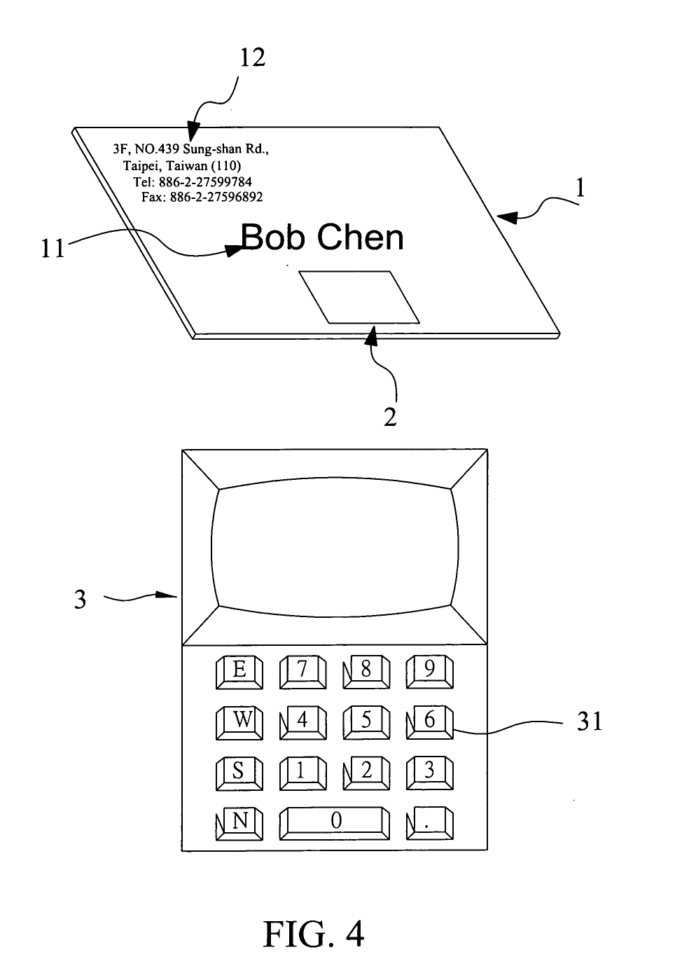

Please refer to FIG. 4, which is a view showing a status of use according to the first preferred embodiment of the present invention. As shown in the figure, a user finds an owner's location for an addressing business card according to the present invention. A receiver 3 coordinated in the present invention is used. The receiver 3 is a GPS (global positioning system) apparatus for locating a global longitude-and-latitude position. When a data element 2 of the addressing business card comprises a description 21 describing a longitude-and-latitude information for the the owner's location, the user directly inputs the longitude-and-latitude information shown in the description 21 through keys 31 on the receiver 3. Hence, the receiver 3 obtains the longitude-and-latitude information described with the description 21 on the data element 2; and displays the location for the longitude-and-latitude information so that the user finds the location of the business card's owner easily.

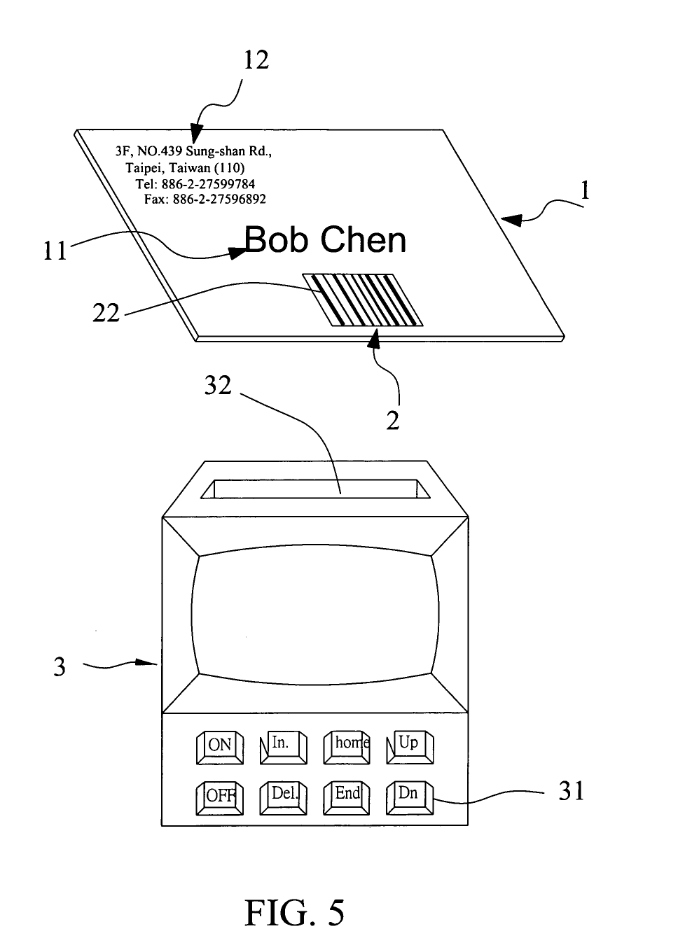

Please further refer to FIG. 5, which is a view showing a status of use according to the second preferred embodiment of the present invention. As shown in the figure, when the data element 2 comprises a bar code 22 for the longitude-and-latitude information, the user directly reads the longitude-and-latitude information s h o w n i n t h e b a r c o d e 2 2 t h r o u g h a reader 32 of the receiver 3; or, the user can directly inputs the numbers of the bar code 22 through the keys 31 on the receiver 3. Hence, the receiver 3 obtains the longitude-and-latitude information for the bar code 22; and displays the location for the longitude-and-latitude information so that the user finds the location of the business card's owner easily.

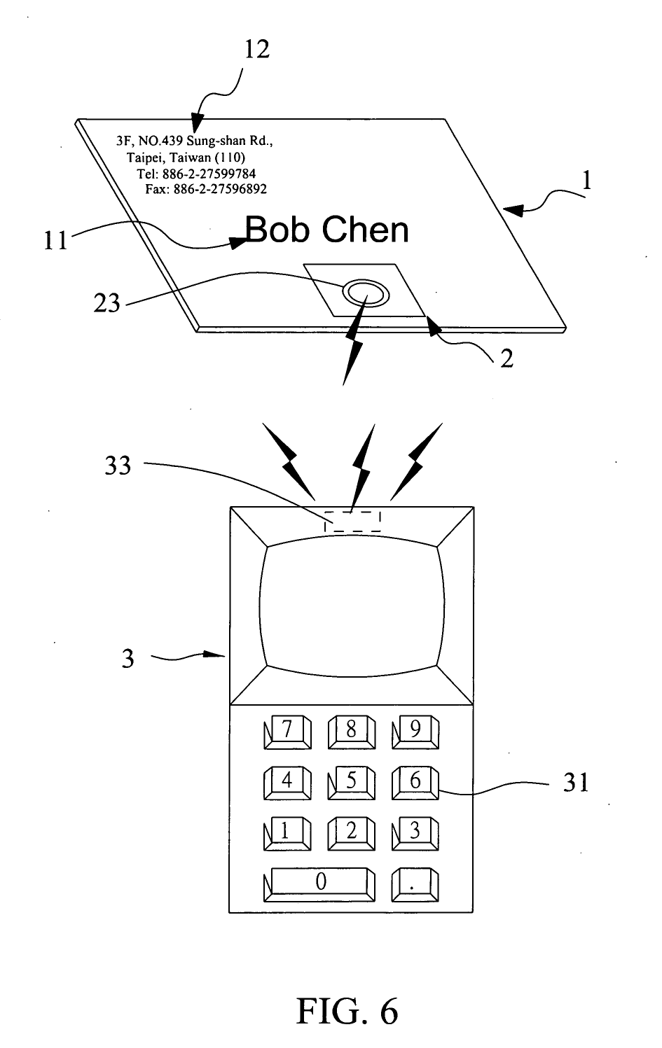

Please further refer to FIG. 6, which is a view showing a status of use according to the third preferred embodiment of the present invention. As shown in the figure, when the data element 2 of the addressing business card comprises a sensor chip 23 storing the longitude-and-latitude information, the user directly retrieves the longitude-and-latitude information stored in the sensor chip 23 through a sensing device 33 of the receiver 3. Hence, the receiver 3 obtains the longitude-and-latitude information stored in the sensor chip 23; and displays the location for the longitude-and-latitude information so that the user finds the location of the business card's owner easily.

To sum up, the present invention is an addressing business card, which comprises a longitude-and-latitude information so that a user can find a location of the business card's owner easily.

The preferred embodiment(s) herein disclosed is/are not intended to unnecessarily limit the scope of the invention. Therefore, simple modifications or variations belonging to the equivalent of the scope of the claims and the instructions disclosed herein for a patent are all within the scope of the present invention.

What is claimed is:

1. An addressing business card, comprising:
(a) a main frame comprising a name area and a communication area; and
(b) a data element deposed on said main frame, said data element comprising a longitude-and-latitude information for a communication address in said communication area.

2. The business card according to claim 1, wherein said data element comprises a description of said longitude-and-latitude information.

3. The business card according to claim 1, wherein said data element comprises a bar code for said longitude-and-latitude information

4. The business card according to claim 1, wherein said data element comprises a sensor chip storing said longitude-and-latitude information.

5. An addressing business card, comprising:
(a) a main frame comprising a name area and a communication area;
(b) a data element deposed on said main frame, said data element comprising a longitude-and-latitude information for a communication address in said communication area; and
(c) a receiver receiving said longitude-and-latitude information in said data element.

6. The business card according to claim 5, wherein said data element comprises a description of said longitude-and-latitude information.

7. The business card according to claim 5, wherein said data element comprises a bar code for said longitude-and-latitude information

8. The business card according to claim 5, wherein said data element comprises a sensor chip storing said longitude-and-latitude information.

9. The business card according to claim 5, wherein said receiver is a GPS (global positioning system) apparatus.
